(19) United States
(12) Patent Application Publication
(10) Pub. No.: US 2014/0308569 A1
(43) Pub. Date: Oct. 16, 2014

(54) BATTERY PACK

(71) Applicant: Samsung SDI Co., Ltd., Yongin-si (KR)

(72) Inventors: Jong-Rock CHOI, Yongin-si (KR); Dong-Rak KIM, Yongin-si (KR); Jeong-Kurn PARK, Yongin-si (KR); In-Seob SONG, Yongin-si (KR)

(21) Appl. No.: 13/928,429

(22) Filed: Jun. 27, 2013

(30) Foreign Application Priority Data
Apr. 15, 2013 (KR) 10-2013-0040818

(51) Int. Cl. H01M 2/20

(52) U.S. Cl. CPC H01M 2/204; H01M 2/206
USPC 429/159

(57) ABSTRACT

A battery pack includes a plurality of secondary batteries, the plurality of secondary batteries including at least a first secondary battery and a second secondary battery, a first pack case having an accommodating portion on which the plurality of secondary batteries are mounted, and a plurality of bus-bars electrically connecting the plurality of secondary batteries together, the bus-bars having a “⊂” shape, the plurality of bus-bars including at least a first bus-bar and a second bus-bar, the first bus-bar being coupled to an end of the first secondary battery, the second bus-bar being coupled to an end of the second secondary battery and facing the first bus-bar.

### CROSS-REFERENCE TO RELATED APPLICATION

This application claims priority to and the benefit of Korean Patent Application No. 10-2013-0040818, filed on Apr. 15, 2013, in the Korean Intellectual Property Office, and entitled: “BATTERY PACK,” the entire contents of which are incorporated herein by reference in their entirety.

### BACKGROUND

1. Field

Embodiments relate to a battery pack.

2. Description of the Related Art

In general, a battery module may be formed by connecting a few to a few tens of secondary batteries to one another. The secondary battery is a battery which can be repetitively charged and discharged.

The battery module having a plurality of secondary batteries connected to one another may be used as a motor driving power source of a hybrid electric vehicle, a power source of portable compact electronic devices such as a cellular phone, a personal computer, and a camcorder, etc.

### SUMMARY

Embodiments are directed to a battery pack, including a plurality of secondary batteries, the plurality of secondary batteries including at least a first secondary battery and a second secondary battery, a first pack case having an accommodating portion on which the plurality of secondary batteries are mounted, and a plurality of bus-bars electrically connecting the plurality of secondary batteries together, the bus-bars having a “⊂” shape, the plurality of bus-bars including at least a first bus-bar and a second bus-bar, the first bus-bar being coupled to an end of the first secondary battery, the second bus-bar being coupled to an end of the second secondary battery and facing the first bus-bar.

The first bus-bar coupled to the end of the first secondary battery and the second bus-bar coupled to the end of the second secondary battery may be in surface contact with each other.

The battery pack may further include a pressure member coupled to the accommodating portion, the pressure member pressing the first and second bus-bars together.

The first bus-bar may include a first coupling portion coupled to the end of the first secondary battery, and first and second extending portions respectively extended in an axial direction of the first secondary battery from opposite sides of the first coupling portion, the second bus-bar may include a second coupling portion coupled to the end of the second secondary battery, and third and fourth extending portions respectively extended in an axial direction of the second secondary battery from opposite sides of the second coupling portion, and the first and third extending portions may be in surface contact with each other, and the second and fourth extending portions may be in surface contact with each other.

The pressure member may include a coupling portion coupled to a lower surface of the accommodating portion, and first and second elastic portions respectively extended from opposite sides of the coupling portion.

The pressure member may be inserted in a central space of the first and second bus-bars.

The first elastic portion may press the first and third extending portions to one side of the accommodating portion, and the second elastic portion may press the second and fourth extending portions to another side of the accommodating portion opposite to the one side.

The pressure member may include a first elastic portion coupled to one surface of the accommodating portion, and a second elastic portion coupled to another surface of the accommodating portion opposite to the one surface of the accommodating portion.

The first and second bus-bars may be inserted between the first and second elastic portions.

The first elastic portion may press the first and third extending portions in the direction of the other surface, and the second elastic portion may press the second and fourth extending portions in the direction of the one surface.

The accommodating portion may include a first battery accommodating portion on which the plurality of secondary batteries are mounted, and a bus-bar accommodating portion on which the first and second bus-bars are mounted.

The pressure member may be coupled to the bus-bar accommodating portion.

The battery pack may further include a second pack case coupled to the first pack case. The second pack case may include a second battery accommodating portion on which the plurality of secondary batteries are mounted.

The ends of the secondary batteries may be respectively coupled to the bus-bars through welding.

The “⊂” shape may include a middle portion, a first extending portion extending from a first end of the middle portion, and a second extending portion extending from a second end of the middle portion opposite the first end.

The middle portion and the first and second extending portions may be plate shaped, and the first and second extending portions may each be substantially orthogonal to the middle portion.

### BRIEF DESCRIPTION OF THE DRAWINGS

Features will become apparent to those of skill in the art by describing in detail example embodiments with reference to the attached drawings in which:

FIG. 1 illustrates an exploded perspective view of a battery pack according to an example embodiment.

FIG. 2 illustrates an assembled perspective view of the battery pack according to an example embodiment.

FIG. 3 illustrates a perspective view of a secondary battery according to an example embodiment.

FIG. 4 illustrates a perspective view showing a state in which a first secondary battery and a second secondary battery are coupled to each other according to an example embodiment.

FIG. 5 illustrates a perspective view of a pressure member according to an example embodiment.

FIG. 6A illustrates a sectional view taken along line A-A′ of FIG. 1, showing a bus-bar accommodating portion and the pressure member.

FIG. 6B illustrates a sectional view showing a state in which a bus-bar is coupled to the pressure member of FIG. 6A.

FIG. 7 illustrates a perspective view showing an example of a lower case and a pressure member coupled thereto according to another example embodiment.

FIG. 8A illustrates a sectional view taken along line A-A′ of FIG. 7, showing a state in which the pressure member and a bus-bar accommodating portion are coupled to each other.

FIG. 8B illustrates a sectional view showing a state in which bus-bars are coupled with the pressure member of FIG. 8A.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

In the following detailed description, only certain example embodiments have been shown and described, simply by way of illustration. As those skilled in the art will realize, the described embodiments may be modified in various different ways, all without departing from the spirit or scope of the embodiments. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween.

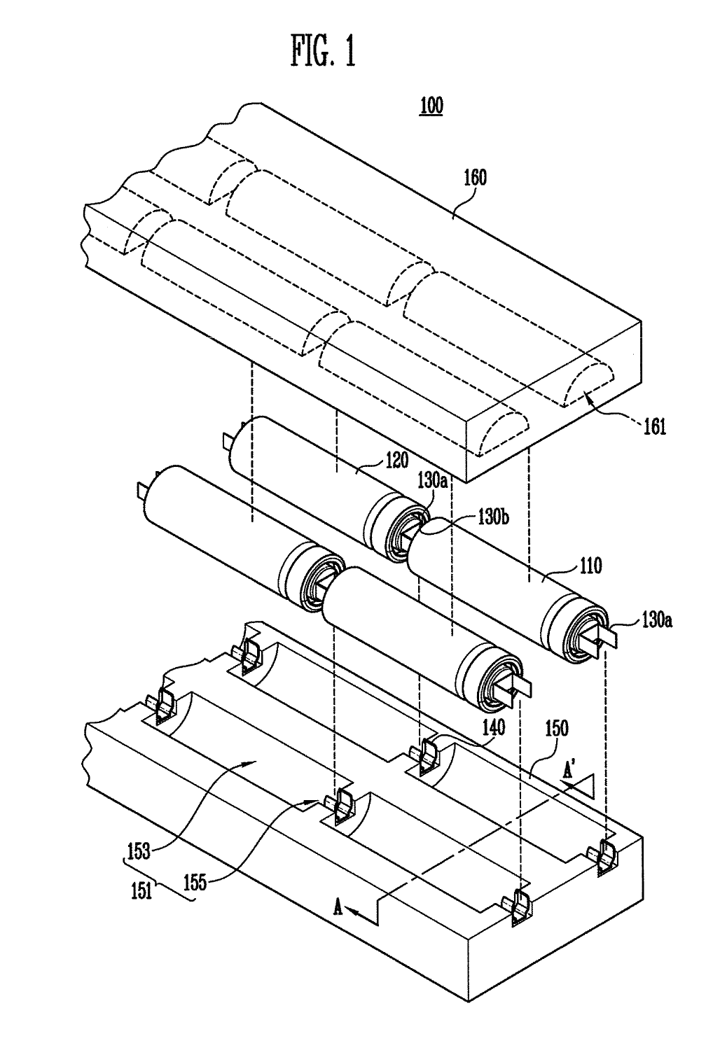

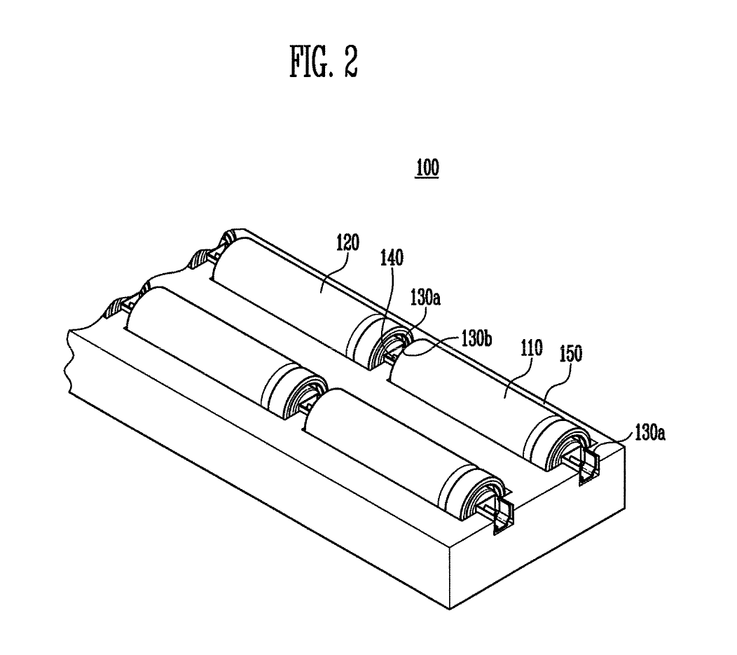

FIG. 1 illustrates an exploded perspective view of a battery pack according to an example embodiment. FIG. 2 illustrates an assembled perspective view of the battery pack according to an example embodiment.

For convenience of illustration, some of a plurality of secondary batteries arranged in a first pack case 150 (hereinafter, referred to as a lower case) and a second pack case 160 (hereinafter, referred to as an upper case) are shown in the figures. Connections between the secondary batteries will be described, based on a first secondary battery 110 and a second secondary battery 120, and the connection between the first and second secondary batteries 110 and 120 is identically applicable to the other secondary batteries. The secondary battery may be, e.g., a lithium-ion secondary battery, etc. The first and second secondary batteries 110 and 120 may be formed as, e.g., a cylindrical secondary battery, a prismatic secondary battery, a pouch-type secondary battery, etc.

Referring to FIGS. 1 and 2, a battery pack 100 according to the present example embodiment may include a first secondary battery 110, a second secondary battery 120, bus-bars 130a and 130b respectively coupled to the first and second secondary batteries 110 and 120 and electrically connecting the first and second secondary batteries 110 and 120 to each other, a pressure member 140 for enhancing close contact between the bus-bars 130a and 130b, and lower and upper cases 150, 160 in which the first and second secondary batteries 110 and 120 are accommodated.

The lower case 150 may have an accommodating portion 151 on which a plurality of the secondary batteries are mounted. The accommodating portion 151 may include a first battery accommodating portion 153 for the first and second secondary batteries 110 and 120, and a bus-bar accommodating portion 155 for the bus-bars 130a and 130b.

The bus-bar accommodating portion 155 and the first battery accommodating portion 153 may be formed in plural numbers in the lower case 150. Portions of the first and second secondary batteries 110 and 120 may be accommodated in the first battery accommodating portion 153, and other portions of the first and second secondary batteries 110 and 120 may be accommodated in a second battery accommodating portion 161 formed in the upper case 160.

A first bus-bar 130a may be coupled to one or both ends of the first secondary battery 110. A second bus-bar 130b may be coupled to one or both ends of the second secondary battery 120. The first and second bus-bars 130a and 130b may come in surface contact with each other so as to electrically connect the first and second secondary batteries 110 and 120 to each other. This is described in further detail below.

The pressure member 140 may be provided in the bus-bar accommodating portion 155. The pressure member 140 may be configured to provide pressure, e.g., tension or compression, so that the first and second bus-bars 130a and 130b are pressed closely to each other.

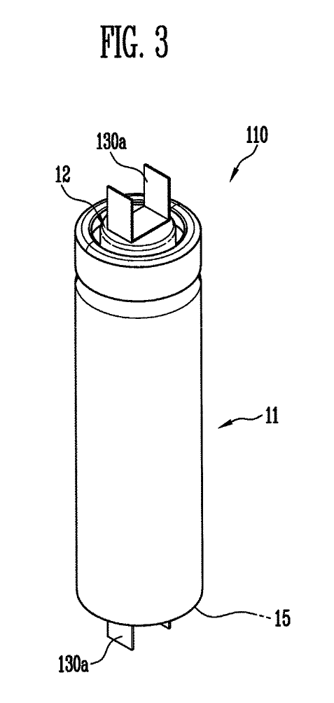

FIG. 3 illustrates a perspective view of a secondary battery according to an example embodiment.

An example structure of secondary batteries applied to the battery pack 100 will be described with reference to FIG. 3. A plurality of the secondary batteries 110 may be formed into the same structure, and thus the first secondary battery 110 will be described as an example.

The first secondary battery 110 may include an electrode assembly having a first electrode plate, a second electrode plate, and a separator interposed between the first and second electrode plates. The first secondary battery may further include a lower case 11 accommodating the electrode assembly therein and a cap assembly 12 sealing the lower case 11.

The electrode assembly and an electrolyte may be provided inside the lower case 11. The electrode assembly may be formed by, e.g., winding or stacking the first and second electrode plates and the separator interposed between the first and second electrode plates. For example, the first electrode plate may be a positive electrode plate including a lithium compound, and the second electrode plate may be a negative electrode plate including carbon. The separator may be made of an insulation material having a plurality of pores. The separator may help ensure that the first and second electrode plates do not come in direct contact with each other while allowing the electrolyte, ions, etc., to move between the first and second electrode plates, so as to enable the flow of current in the electrode assembly. First and second electrode tabs may be provided to the first and second electrode plates, respectively. The first and second electrode tabs may be connected to the cap assembly 12 and the lower case 11, respectively. The first and second electrode tabs may have different polarities. Thus, the cap assembly 12 and the lower case 11 may have different polarities. The first and second electrode tabs may be electrically connected to an external electronic device. The lower case 11 may be formed in the shape of, e.g., a can, and may be made of, e.g., iron or aluminum.

Respective first bus-bars 130a may be electrically coupled to the respective ends of the first secondary battery 110 at the cap assembly 12 and/or a lower surface 15 of the lower case 11. The first bus-bar 130a may be coupled to the cap assembly 12 and/or the lower surface 15 of the lower case 11 through, e.g., welding. The cap assembly 12 and/or the lower surface 15 of the lower case 11 may include a flat welding portion (not shown) in order to increase the coupling performance of the welding. Hereinafter, for convenience of description, one end of the secondary battery 110 (or 120) means the cap assembly 12 or the lower surface 15 of the lower case 11.

FIG. 4 illustrates a perspective view showing a state in which the first secondary battery 110 and the second secondary battery 120 are coupled to each other according to an example embodiment.

Referring to the example embodiment shown in FIG. 4, the first bus-bar 130a coupled to one end of the first secondary battery 110 and the second bus-bar 130b coupled to one end of the second secondary battery 120 may each have a “⊂” shape. The first bus-bar 130a and the second bus-bar 130b may come into surface contact with each other so as to electrically connect the first and second secondary batteries 110 and 120 to each other.

For example, the first bus-bar 130a may include a first coupling portion 133a coupled to the one end of the first secondary battery 110, and first and second extending portions 135a and 135b respectively extended in the axis direction of the first secondary battery 110 (e.g., vertically with respect a longitudinal dimension of the first secondary battery 110) from opposite sides of the first coupling portion 133a.

The second bus-bar 130b may include a second coupling portion 133b coupled to the one end of the second secondary battery 120, and third and fourth extending portions 135c and 135d respectively extended in the axis direction of the second secondary battery 120 (e.g., vertically with respect to a longitudinal dimension of the second secondary battery 120) from opposite sides of the second coupling portion 133b.

The first extending portion 135a may come in surface contact with the third extending portion 135c. The second extending portion 135b may come in surface contact with the fourth extending portion 135d. In an implementation, the first and second bus-bars 130a and 130b may be configured in an interleaved or staggered arrangement such that an outer face of the first extending portion 135a of the first bus-bar 130a contacts an inner face of the third extending portion 135c of the second bus-bar 130b, and an inner face of the second extending portion 135b of the first bus-bar 130a contacts an outer face of the fourth extending portion 135d of the second bus-bar 130b. In another implementation, the first and second bus-bars 130a and 130b may be configured such that one is surrounded by the other, e.g., the extending portions 135a, 135b of the first bus-bar 130a may be interposed between the extending portions 135c, 135d of the second bus-bar 130b such that an outer face of the first extending portion 135a of the first bus-bar 130a contacts an inner face of the third extending portion 135c of the second bus-bar 130b, and an outer face of the second extending portion 135b of the first bus-bar 130a contacts an inner face of the fourth extending portion 135d of the second bus-bar 130b.

The contact surface between the first and second bus-bars 130a and 130b may be wide as a result of the contact between the respective extending portions. Thus, the contact between the first and second bus-bars 130a and 130b may not be easily interrupted or cut off by external vibration or impact applied to the battery pack 100.

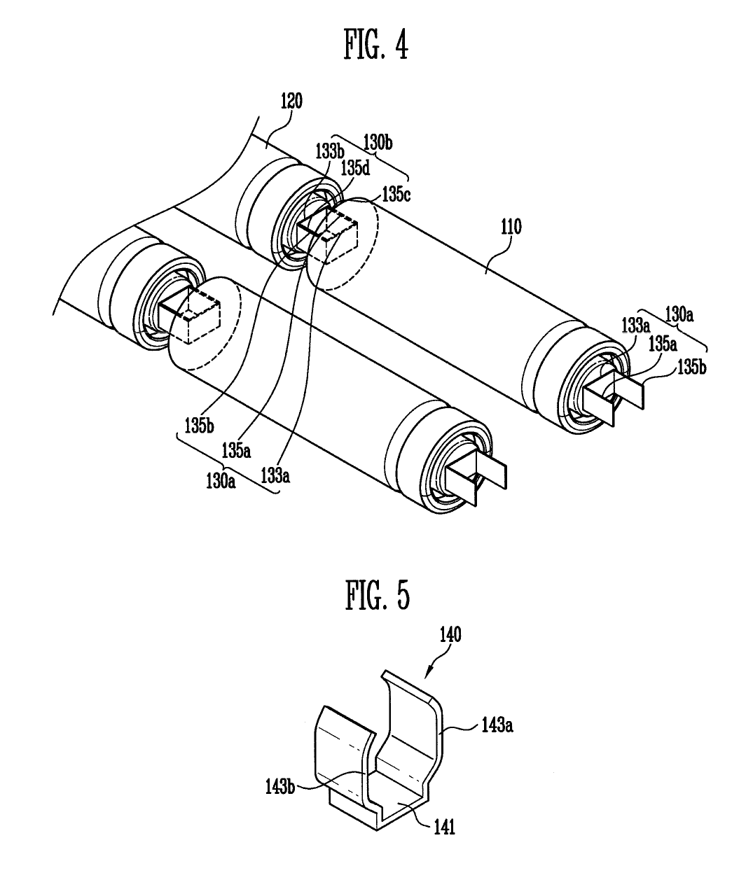

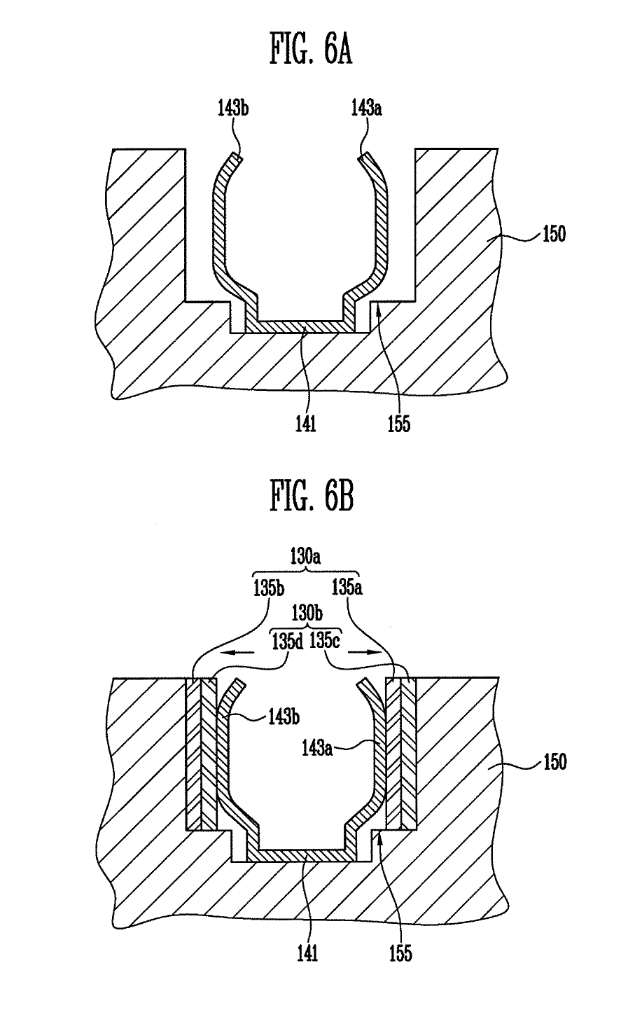

FIG. 5 illustrates a perspective view of a pressure member 141 according to an example embodiment. FIG. 6A illustrates a sectional view taken along line A-A′ of FIG. 1, showing the bus-bar accommodating portion of the lower case 150 and the pressure member 141. FIG. 6B is a sectional view showing a state in which the bus-bars 130a and 130b are coupled with pressure applied by the pressure member 141 of FIG. 6A.

Referring to FIGS. 5 to 6B, the pressure member 140 may include a coupling portion 141, which may be coupled to the bus-bar accommodating portion 155 of the lower case 150. The pressure member 140 may include first and second elastic portions 143a and 143b respectively extended in the insertion direction of the bus-bars 130a and 130b from both sides of the coupling portion 141. The first and second elastic portions 143a and 143b may have elasticity so as to apply pressure to the first and second bus-bars 130a and 130b.

The pressure member 140 may be inserted between the first and second bus-bars 130a and 130b, e.g., in a space between the first and third extending portions 135a and 135c (on one side of the space), and the second and fourth extending portions 135b and 135d (on the opposite side of the space). The first elastic portion 143a may have elasticity, and thus may press the first and third extending portions 135a and 135c to one side, e.g., away from the central space. The first elastic portion 143a may be aligned at a position at which the first and third extending portions 135a and 135c overlap. The first elastic portion 143a may be disposed so as to press laterally and cause the bus-bar accommodating portion 155 and the first extending portion 135a to come into surface contact with each other. Similarly, the second elastic portion 143b may press the second and fourth extending portions 135b and 135d to one side, and may press the fourth extending portion 135d against the bus-bar accommodating portion so that the bus-bar accommodating portion 155 and the fourth extending portion 135d come into surface contact with each other.

As described above, the pressure member 140 may help bring the first and second bus-bars 130a and 130b into close contact with each other. Thus, the contact between the first and second bus-bars 130a and 130b may not be easily cut off by external vibration or impact applied to the battery pack 100.

Although it has been illustrated in FIG. 6B that the second extending portion 135b of the first bus-bar 130a and the third extending portion 135c of the second bus-bar 130b come in surface contact with respective surfaces of the bus-bar accommodating portion 155, it will be apparent that the first extending portion 135a of the first bus-bar 130a and the fourth extending portion 135d of the second bus-bar 130b may come in surface contact with respective surfaces of the bus-bar accommodating portion 155.

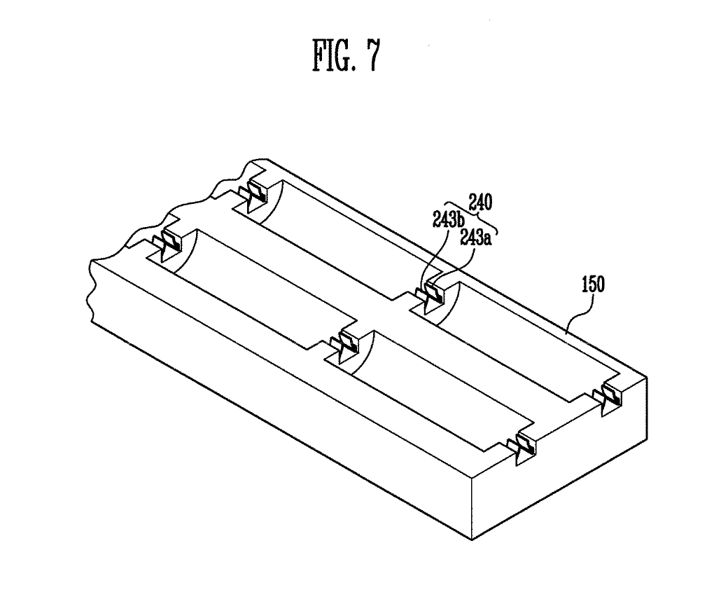

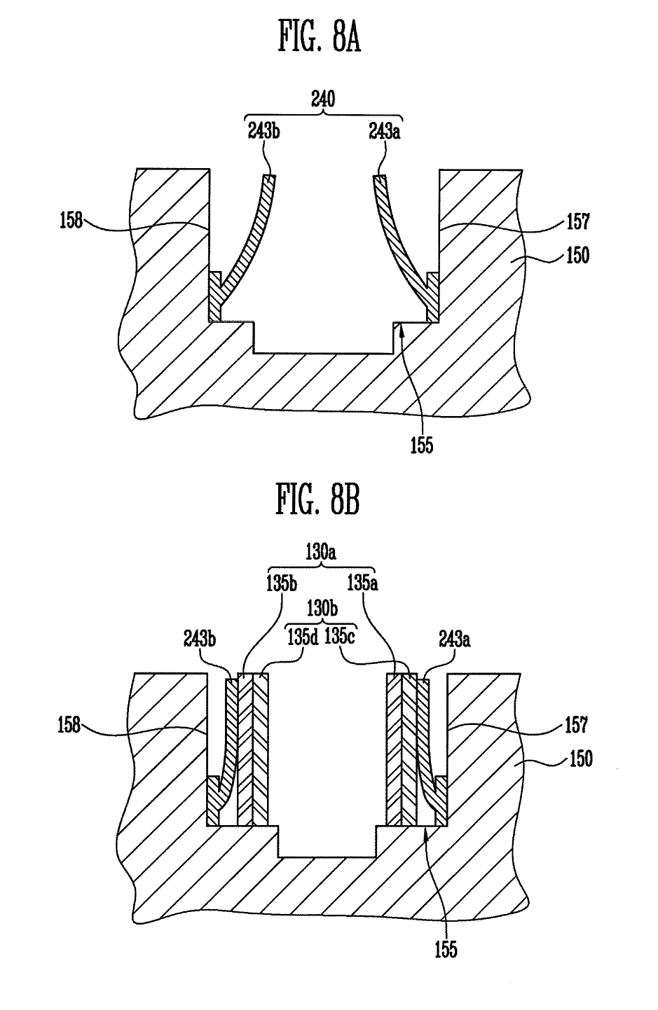

FIG. 7 illustrates a perspective view showing an example of the lower case 150 with a pressure member 240 coupled thereto according to another example embodiment. FIG. 8A illustrates a sectional view taken along line A-A′ of FIG. 7, showing a state in which the pressure member 240 and a bus-bar accommodating portion 155 are coupled to each other. FIG. 8B illustrates a sectional view showing a state in which the bus-bars 130a, 130b are coupled with the pressure member 240 of FIG. 8A. Hereinafter, the pressure member 240 according to the present example embodiment will be described with reference to FIGS. 7 to 8B. Here, components identical or corresponding to those of the previous example embodiment are designated by like reference numerals, and details thereof may be omitted to avoid redundancy.

Referring to FIGS. 7 to 8B, the pressure member 240 may include first and second elastic portions 243a and 243b respectively coupled to one surface 157 of the bus-bar accommodating portion 155 and another surface 158 opposite to the one surface 157.

The first and second bus-bars 130a and 130b may be inserted between the first and second elastic portions 243a and 243b. The first elastic portion 243a may press the first and third extending portions 135a and 135c in the direction of the other surface 158, and the second elastic portion 243b may press the second and fourth extending portions 135b and 135d in the direction of the one surface 157, so that the first and second bus-bars 130a and 130b are pressed closely together. Accordingly, contact between the first and second bus-bars 130a and 130b may be maintained even when exposed to external vibration or impact.

The shape of the first and second elastic portions 243a and 243b shown in FIGS. 7 to 8B is merely an example of a structure for pressing the first and second bus-bars 130a and 130b, and embodiments of various structures having elasticity, which press the first and second bus-bars 130a and 130b, are applicable to the first and second elastic portions 243a and 243b.

By way of summation and review, a battery module may have a structure in which secondary batteries electrically connected to one another are arranged in a battery pack. A method of performing bus-bar welding on terminals of secondary batteries or connecting secondary batteries through a separate pressure member may be used in order to electrically connect the secondary batteries to one another. However, when the bus-bar welding is used, if one secondary battery has a defect, then the entire bundle of secondary batteries connected through the bus-bar welding may have to be replaced. Also, if the secondary batteries are connected using the separate pressure member, contact between secondary batteries may be momentarily or permanently lost.

As described above, embodiments may provide a battery pack that helps maintain the coupling between secondary batteries, which may improve safety of the battery pack. One or both ends of the secondary batteries may be coupled to the bus-bar through welding.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A battery pack, comprising:
a plurality of secondary batteries, the plurality of secondary batteries including at least a first secondary battery and a second secondary battery;
a first pack case having an accommodating portion on which the plurality of secondary batteries are mounted; and
a plurality of bus-bars electrically connecting the plurality of secondary batteries together, the bus-bars having a “⊂” shape, the plurality of bus-bars including at least a first bus-bar and a second bus-bar, the first bus-bar being coupled to an end of the first secondary battery, the second bus-bar being coupled to an end of the second secondary battery and facing the first bus-bar.

2. The battery pack as claimed in claim 1, wherein the first bus-bar coupled to the end of the first secondary battery and the second bus-bar coupled to the end of the second secondary battery are in surface contact with each other.

3. The battery pack as claimed in claim 2, further comprising a pressure member coupled to the accommodating portion, the pressure member pressing the first and second bus-bars together.

4. The battery pack as claimed in claim 3, wherein:
the first bus-bar includes a first coupling portion coupled to the end of the first secondary battery, and first and second extending portions respectively extended in an axial direction of the first secondary battery from opposite sides of the first coupling portion,
the second bus-bar includes a second coupling portion coupled to the end of the second secondary battery, and third and fourth extending portions respectively extended in an axial direction of the second secondary battery from opposite sides of the second coupling portion, and
the first and third extending portions are in surface contact with each other, and the second and fourth extending portions are in surface contact with each other.

5. The battery pack as claimed in claim 4, wherein the pressure member includes:
a coupling portion coupled to a lower surface of the accommodating portion, and
first and second elastic portions respectively extended from opposite sides of the coupling portion.

6. The battery pack as claimed in claim 5, wherein the pressure member is inserted in a central space of the first and second bus-bars.

7. The battery pack as claimed in claim 6, wherein:
the first elastic portion presses the first and third extending portions to one side of the accommodating portion, and
the second elastic portion presses the second and fourth extending portions to another side of the accommodating portion opposite to the one side.

8. The battery pack as claimed in claim 4, wherein the pressure member includes:
a first elastic portion coupled to one surface of the accommodating portion, and
a second elastic portion coupled to another surface of the accommodating portion opposite to the one surface of the accommodating portion.

9. The battery pack as claimed in claim 8, wherein the first and second bus-bars are inserted between the first and second elastic portions.

10. The battery pack as claimed in claim 9, wherein:
the first elastic portion presses the first and third extending portions in the direction of the other surface, and
the second elastic portion presses the second and fourth extending portions in the direction of the one surface.

11. The battery pack as claimed in claim 3, wherein the accommodating portion includes:
a first battery accommodating portion on which the plurality of secondary batteries are mounted, and
a bus-bar accommodating portion on which the first and second bus-bars are mounted.

12. The battery pack as claimed in claim 11, wherein the pressure member is coupled to the bus-bar accommodating portion.

13. The battery pack as claimed in claim 9, further comprising a second pack case coupled to the first pack case,
wherein the second pack case includes a second battery accommodating portion on which the plurality of secondary batteries are mounted.

14. The battery pack as claimed in claim 1, wherein the ends of the secondary batteries are respectively coupled to the bus-bars through welding.

15. The battery pack as claimed in claim 1, wherein the shape includes a middle portion, a first extending portion extending from a first end of the middle portion, and a second extending portion extending from a second end of the middle portion opposite the first end.

16. The battery pack as claimed in claim 15, wherein the middle portion and the first and second extending portions are plate shaped, and the first and second extending portions are each substantially orthogonal to the middle portion.
